(19) United States
(12) Patent Application Publication
(10) Pub. No.: US 2018/0049121 A1
(43) Pub. Date: Feb. 15, 2018

(54) RADIO COMMUNICATION SYSTEM, RADIO COMMUNICATION NETWORK, RADIO TERMINAL, AND RADIO COMMUNICATION METHOD

(71) Applicant: NEC CORPORATION, Tokyo (JP)

(72) Inventors: Toru YAMADA, Tokyo (JP); Akira KAMEI, Tokyo (JP); Masahiro SERIZAWA, Tokyo (JP); Hotaka SUGANO, Tokyo (JP); Satoshi HASEGAWA, Tokyo (JP); Masashi SHIMOMA, Tokyo (JP)

(73) Assignee: NEC CORPORATION, Tokyo (JP)

(21) Appl. No.: 15/559,554

(22) PCT Filed: Mar. 18, 2016
(86) PCT No.: PCT/JP2016/058790

§ 371 Date: Sep. 19, 2017

(30) Foreign Application Priority Data
Mar. 23, 2015 (JP) 2015-059342

(51) Int. Cl. H04W 52/02; H04W 76/04

(52) U.S. Cl. CPC H04W 52/0212; H04W 76/048; H04W 4/005

(57) ABSTRACT

The present disclosure is a radio communication system in which a radio terminal is able to perform discontinuous reception in a predetermined cycle, including transmission means for transmitting non-reception period transition information about a transition to a non-reception period to the radio terminal, and discontinuous reception control means for changing to the non-reception period of the discontinuous reception based on the non-reception period transition information when the radio terminal is in a reception period of the discontinuous reception.

### TECHNICAL FIELD

The present disclosure relates to a radio communication system, a radio communication network, a radio terminal, and a radio communication method.

### BACKGROUND ART

3GPP LTE (Long Term Evolution), which is one of the next-generation cellular systems, supports a discontinuous reception (DRX: Discontinuous Reception) function for a radio terminal in order to reduce the power consumption of the radio terminal (Non-Patent Literature 1 and 2). In the LTE, a period called a DRX cycle, composed of a reception period (an On-Duration) and a subsequent non-reception period (an Opportunity for DRX) is defined. Further, the DRX is implemented by repeating these periods.

In the On-duration period, the radio terminal has to receive a downlink control channel (i.e., a PDCCH: Physical Downlink Control Channel) all the time, whereas in the Opportunity for DRX, the radio terminal does not have to receive the PDCCH. Note that when the radio terminal fails in receiving data in the On-duration period and the same data is re-transmitted in or after the On-duration period, the radio terminal extends the period for receiving the PDCCH.

Hereinafter, a period in which a radio terminal performing a DRX operation receives a PDCCH is called an “Active Time”. Further, the On-duration is the minimum value for the Active Time. Further, for each radio terminal, two DRX states (levels), i.e., “ShortDRX” and “LongDRX” having different lengths for the Opportunity for DRX can be set. In the LTE, when a radio terminal in the ShortDRX state has not performed data reception for a certain period, the radio terminal performs DRX state control for changing to the LongDRX state. Further, the radio terminal uses a timer (a drxShortCycleTimer) to determine whether it should change from the ShortDRX state to the LongDRX state. In this way, it is possible to set a DRX state (level) suitable for the frequency of occurrences of data reception performed by the radio terminal and thereby to reduce the power consumption of the radio terminal.

Incidentally, in addition to the use of communication networks in terminals that are directly used by people such as smartphones and PCs (Personal Computers), the use of communication networks is also spreading to other terminals, i.e., terminals such as meters, vending machines, electronic advertisements, and so on. The communication that is not directly used by people as described above is called MTC (Machine Type Communication) and terminals that are not directly used by people as communication means are called MTC terminals. In the case of the MTC, it is considered that the frequency of occurrences of communication that the MTC terminal needs to perform is lower than that of ordinary terminals (e.g., once a day, once a week, once a month, or the like) and the amount of data that is transmitted/received in one communication is also not large. Meanwhile, there is a high possibility that the power supply of an MTC terminal cannot be frequently replaced or recharged. Therefore, it is expected that an MTC terminal needs to have very low power consumption.

### CITATION LIST

### Non Patent Literature

Non-patent Literature 1: 3GPP TS36. 300v900 (the Internet <URL>http:www.3gpp.org/ftp/Specs/html-info/36300.htm)
Non-patent Literature 2: 3GPP TS36. 321v860 (the Internet <URL>http:www.3 gpp.org/ftp/Specs/html-info/36321.htm)

### SUMMARY OF INVENTION

### Technical Problem

However, when the cycle of the DRX is simply increased in order to reduce the power consumption, there is a possibility that the terminal fails to receive system information and/or paging information transmitted from a communication network.

On the other hand, when the cycle of the DRX is reduced, the power consumption could increase.

Therefore, the object of the present invention is to provide a radio communication system, a radio communication network, a radio terminal, and a radio communication method capable of reducing the power consumption of the radio terminal while securing the opportunity in which the radio terminal appropriately receives information from the radio network (i.e., from a base station).

### Solution to Problem

An aspect of the present disclosure is a radio communication system in which a radio terminal is able to perform discontinuous reception in a predetermined cycle, including: transmission means for transmitting non-reception period transition information about a transition to a non-reception period to the radio terminal; and discontinuous reception control means for changing to the non-reception period of the discontinuous reception based on the non-reception period transition information when the radio terminal is in a reception period of the discontinuous reception.

Another aspect of the present disclosure is a radio network in a communication system in which a radio terminal is able to perform discontinuous reception in a predetermined cycle, including transmission means for transmitting non-reception period transition information about a transition to a non-reception period to the radio terminal.

Another aspect of the present disclosure is a radio terminal configured to perform discontinuous reception of data, including: reception means for receiving non-reception period transition information about a transition to a non-reception period; and discontinuous reception control means for changing to the non-reception period of the discontinuous reception based on the non-reception period transition information during a reception period of the discontinuous reception.

Another aspect of the present disclosure is a radio communication method in which a radio terminal is able to perform discontinuous reception in a predetermined cycle, including transmitting non-reception period transition information about a transition to a non-reception period from a radio network side to the radio terminal, in which the radio terminal changes to the non-reception period of the discontinuous reception based on the non-reception period transition information during a reception period of the discontinuous reception.

### Advantageous Effects of Invention

According to the present disclosure, it is possible to reduce the power consumption of a radio terminal while securing the opportunity in which the radio terminal appropriately receives information from a radio network (i.e., from a base station).

### BRIEF DESCRIPTION OF DRAWINGS

FIG. 1 is a block diagram for explaining an outline of the present disclosure;

FIG. 2 shows an example of a case in which a radio terminal changes from a reception period to a non-reception period immediately after receiving non-reception period transition information;

FIG. 3 shows an example of a schematic configuration of a radio communication system according to an embodiment of the present disclosure;

FIG. 4 is a block diagram of a radio terminal (UE) 10 according to the embodiment;

FIG. 5 is a block diagram of a radio base station (eNB) 20 according to the embodiment;

FIG. 6 is a block diagram of a network management apparatus 30 according to the embodiment;

FIG. 7 shows a discontinuous reception (DRX: Discontinuous Reception) operation performed by a radio terminal in a radio communication system according to the embodiment;

FIG. 8 shows a discontinuous reception (DRX: Discontinuous Reception) operation performed by a radio terminal in a radio communication system according to the embodiment;

FIG. 9 shows a discontinuous reception (DRX: Discontinuous Reception) operation performed by a radio terminal in a radio communication system according to the embodiment;

FIG. 10 is a diagram for explaining operations that are performed when a Last data Indication (transmission end information) indicating the completion of transmission of transmission data to be transmitted to UE 10 is transmitted and performed after receiving the Last data Indication;

FIG. 11 is a diagram for explaining operations that are performed when the Last data Indication (the transmission end information) indicating the completion of transmission of transmission data in the UE 10 is received;

FIG. 12 is a diagram for explaining operations that are performed when the Last data Indication (the transmission end information) indicating the completion of transmission of transmission data in the UE 10 is received;

FIG. 13 shows another aspect of a radio terminal (UE) 1 in a radio communication system according to the embodiment; and

FIG. 14 shows another aspect of a base station and a radio network in a radio communication system according to the embodiment.

### DESCRIPTION OF EMBODIMENTS

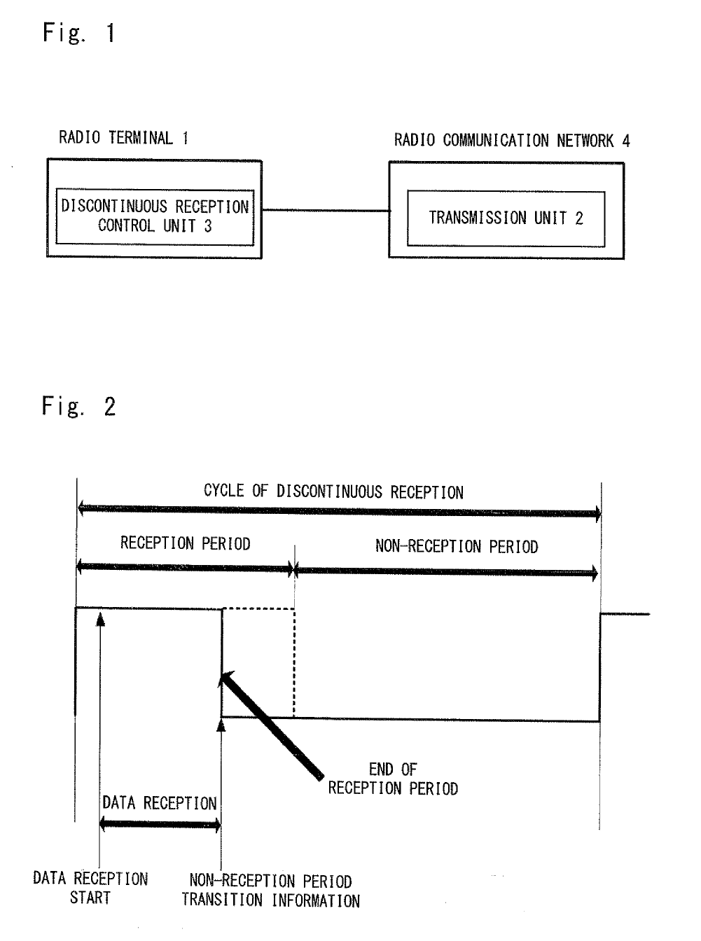

An outline of the present disclosure is explained. FIG. 1 is a block diagram for explaining an outline of the present disclosure.

The present disclosure is a radio communication system in which a radio terminal 1 is able to perform discontinuous reception in a predetermined cycle, including a transmission unit 2 that transmits non-reception period transition information about a transition to a non-reception period to the radio terminal 1, and a discontinuous reception control unit 3 that changes to the non-reception period of the discontinuous reception based on the non-reception period transition information when the radio terminal 1 is in a reception period of the discontinuous reception. Note that, in general, the transmission unit 2 is disposed on a radio communication network 4 side and the discontinuous reception control unit 3 is disposed in the radio terminal 1.

Note that examples of the radio terminal 1 include an MTC (Machine Type Communication) terminal as well as a smartphone and a PC, though the radio terminal 1 is not limited to these examples. In particular, since the MTC terminal is required to reduce the consumed power, the present disclosure is effective for it.

Further, examples of discontinuous reception performed by a radio terminal include DRX (Discontinuous Reception) in 3GPP LTE (Long Term Evolution) and examples of the data reception period include an On-Duration and an Active Time. Further, examples of the data non-reception period include an Opportunity for DRX. However, the discontinuous reception is not limited to the aforementioned discontinuous reception.

Next, the transmission unit 2 is explained.

The transmission unit 2 transmits non-reception period transition information about a transition to a non-reception period to the radio terminal 1. This non-reception period transition information serves as a rough indication for the radio terminal 1 to change from a reception period of discontinuous reception to a non-reception period thereof. Examples of the non-reception period transition information include a transition instruction to change from a reception period to a non-reception period and transmission end information about the end of data to be transmitted to the radio terminal 1.

Examples of the transmission end information include transmission end information directly indicating the end of data and transmission end information indirectly indicating the end of data. Examples of the transmission end information indirectly indicating the end of data include information on the size of data to be transmitted and information on an expected transmission time until the completion of data transmission.

Next, the following methods for transmitting non-reception period transition information to the radio terminal 1 are conceivable.
(1) A method for transmitting non-reception period transition information by incorporating it into transmission data transmitted to the radio terminal 1.
(2) A method for transmitting non-reception period transition information as a message separate from transmission data transmitted to the radio terminal 1.

Either of these methods may be used in the present disclosure.

Further, the following methods for creating non-reception period transition information transmitted to the radio terminal 1 are conceivable.
(1) A case in which non-reception period transition information is a transition instruction to change to a non-reception period, end information directly indicating the end of data, or the like.

In the case in which the transmission unit 2 is disposed in a base station, at the point when no transmission data to be transmitted to the radio terminal 1 is left in a transmission buffer of the base station, it is determined that transmission data is finished and a transition instruction or transmission end information is generated and transmitted. Further, in the case in which the transmission unit 2 is disposed in a core network side, an entity on the core network side can monitor a higher-level layer. Therefore, there is a method in which a transmission data completion signal or transmission end information is transmitted from a core network side to a base station at the point when the transmission of transmission data to be transmitted to the radio terminal 1 is completed, and the base station transmits a transition instruction or the transmission end information to the radio terminal 1.
(2) A case in which non-reception period transition information is end information indirectly indicating the end of data or the like.

When non-reception period transition information is information on the size of data, information on an expected transmission time until the completion of data transmission, or the like, the size of the whole data to be transmitted to the radio terminal 1 is calculated and non-reception period transition information is thereby generated in a radio communication network (a base station or a core network side). Further, in the case of the expected transmission time information, a transmission time until the completion of transmission of the whole data to be transmitted to the radio terminal 1 is estimated and created while taking quality of communication with the radio terminal 1 into account in the base station or the core network side.

Note that the term “transmission data” may be the whole transmission data to be transmitted to the radio terminal 1 for transmitting predetermined information to the radio terminal 1, or may be the whole transmission data to be transmitted to the radio terminal 1 within a predetermined period.

Next, the discontinuous reception control unit 3 is explained.

Data is received in discontinuous reception in the radio terminal 1. A certain period is given to a reception period in the discontinuous reception. Even when the reception of data is completed during this reception period, the radio terminal 1 is still in the state in which it can receive data in the reception period. However, in the present disclosure, the discontinuous reception control unit 3 stops the data reception based on non-reception period transition information during the reception period in the discontinuous reception even when there is a remaining period in the reception period and controls the communication process into a non-reception period, i.e., into a sleep state.

There are the following methods for changing from a reception period to a non-reception period.
(1) A case in which non-reception period transition information is a transition instruction to change to a non-reception period, end information directly indicating the end of data, or the like.

When non-reception period transition information is received, the radio terminal changes from a reception period to a non-reception period at a predetermined timing. For example, when decoding has succeeded after the reception, the radio terminal changes at that timing. FIG. 2 shows an example of a case in which the radio terminal changes from a reception period to a non-reception period immediately after receiving non-reception period transition information.
(2) A case in which non-reception period transition information is end information indirectly indicating the end of data or the like.

When the non-reception period transition information is data size information, the radio terminal 1 performs a process for counting the size of received data. Then, when the data size reaches a necessary data size, the radio terminal changes from a reception period to a non-reception period. Further, when the non-reception period transition information is expected transmission time information, the reception time is counted on the radio terminal 1 side. Therefore, the radio terminal 1 is equipped with a timer that measures a data reception time, and performs the management of the start and the end of the timer and the calculation for assurance against variations in the reception time due to the communication quality. Then, when their conditions are met, the radio terminal changes from a reception period to a non-reception period.

By doing so, it is possible to reduce the consumed power of the radio terminal even more than in the related art. In particular, it is effective for MTC terminals for which there are a lot of cases in which the amount of data that the MTC terminal actually receives is smaller than the amount of data that the MTC terminal can receive within a predefined reception period (e.g., within an On-Duration). Therefore, it is possible to reduce the power consumption.

Next, embodiments according to the present disclosure are explained in detail with reference to the drawings. Note that in the below-shown embodiments, “3GPP LTE (Long Term Evolution)” is assumed to be a radio communication system (a cellular system). Further, the following explanation is given by using a Last data Indication (transmission end information) indicating the end of transmission data as an example of non-reception period transition information.

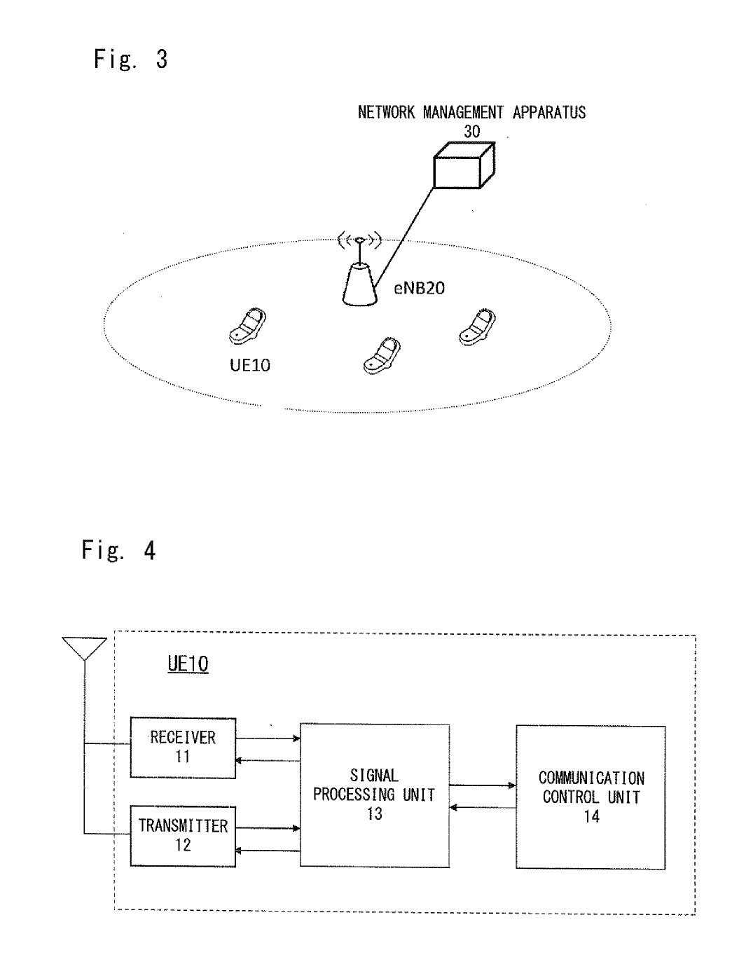

FIG. 3 shows an example of a schematic configuration of a radio communication system according to an embodiment of the present disclosure.

The radio communication system according to this embodiment includes radio terminals (UE: User Equipment) UE 10, a radio base station (an eNB: evolved NodeB) eNB 20, and a network management apparatus 30.

FIG. 4 is a block diagram of the radio terminal (UE) 10 according to this embodiment.

In FIG. 4, the UE 10 includes a receiver 11, a transmitter 12, a signal processing unit 13, and a communication control unit 14.

The receiver 11 and the transmitter 12 are units that perform reception and transmission, respectively, of a radio signal from and to the eNB 20. The signal processing unit 13 is a unit that generates a radio signal for transmitting given information to the eNB 20, restores a received radio signal to original information, and so on. The communication control unit 14 is a unit that instructs to generate a transmission signal to the signal processing unit 13, restore information, and so on. Further, DRX control of the UE is also managed by this communication control unit 14 and it corresponds to the above-described discontinuous reception control unit 3.

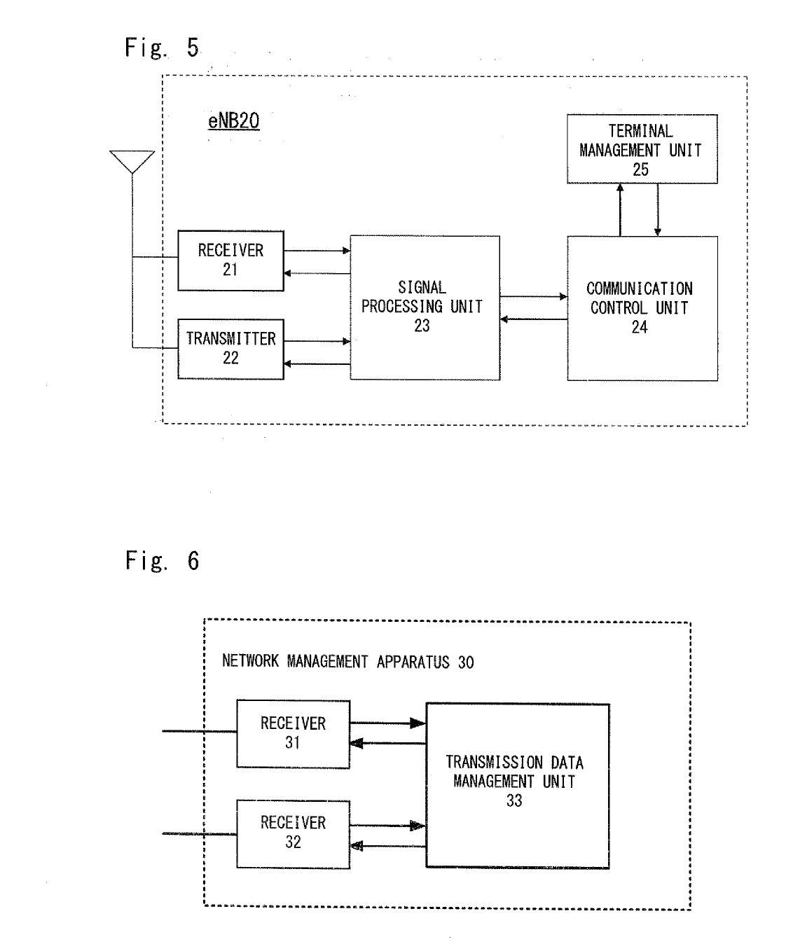

FIG. 5 is a block diagram of the radio base station (eNB) 20 according to this embodiment.

In FIG. 5, the eNB 20 includes a receiver 21, a transmitter 22, a signal processing unit 23, a communication control unit 24, and a terminal management unit 25. Basically, the receiver 21, the transmitter 22, the signal processing unit 23, and the communication control unit 24 have functions similar to those of the UE 10. Further, the communication control unit 24 also has functions of receiving a Last data Indication (transmission end information) from the network management apparatus 30 and transferring it to the UE 10. The terminal management unit 25 individually manages each of a plurality of UEs.

FIG. 6 is a block diagram of the network management apparatus 30 according to this embodiment.

The network management apparatus 30 includes a receiver 31 that receives a signal from the radio base station (eNB) 20, a transmitter 32 that transmits a signal to the eNB 20, and a transmission data management unit 33 that manages data to be transmitted to the UE 10. The transmission data management unit 33 has functions of managing data to be transmitted to the UE 10 and transmitting, when the transmission of transmission data to be transmitted to the UE 10 is completed, a Last data Indication (transmission end information) to the eNB 20.

Next, a discontinuous reception (DRX: Discontinuous Reception) operation performed by a radio terminal in a radio communication system according to this embodiment is explained.

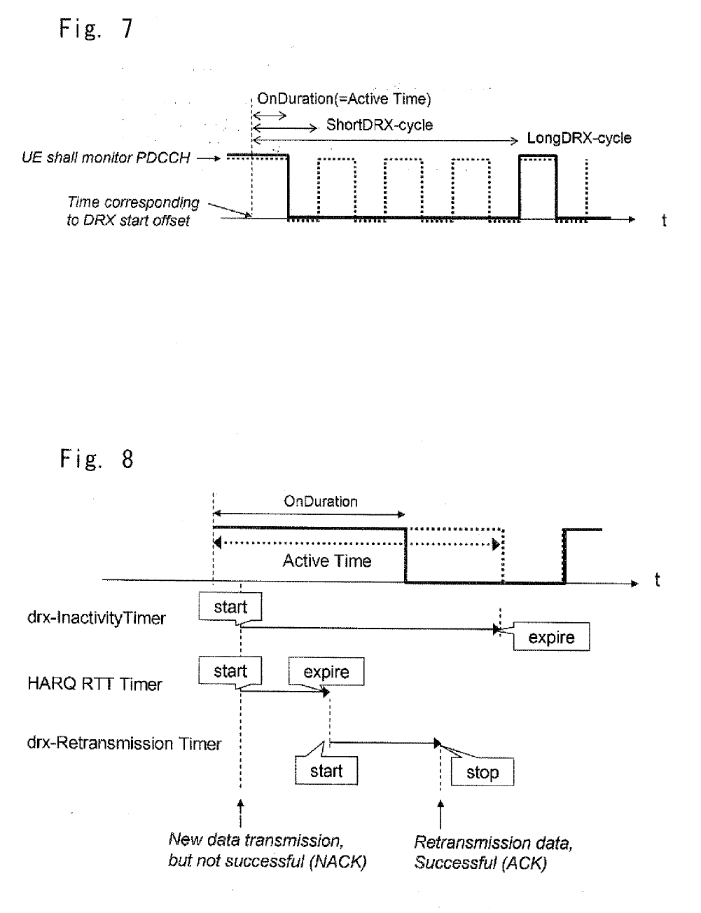

FIGS. 7 to 9 show discontinuous reception (DRX: Discontinuous Reception) operations performed by the radio terminal in the radio communication system according to this embodiment.

Firstly, as shown in FIG. 7, a DRX cycle, which is a cycle of discontinuous reception, is composed of a period in which the radio terminal has to continuously receive a downlink control channel PDCCH (Physical Downlink Control Channel) (i.e., an On-Duration) and a period in which the radio terminal does not have to receive the PDCCH (i.e., an Opportunity for DRX). Note that the former is also called a Wake up period (an Active Time) and the latter is also called a Sleep period. Further, the latter may be a period in which the PDCCH is not received or may be a period in which the PDCCH must not be received.

Note that data is transmitted by using a PDSCH (Physical Downlink Shared Channel) and the PDCCH includes scheduling information of the PDSCH. Therefore, after receiving the PDCCH and detecting the scheduling information, the data designated by the detected scheduling information can be received.

In the DRX cycle, there are two types of DRX, i.e., ShortDRX and LongDRX. The length of the On-Duration of the ShortDRX is the same as that of the LongDRX. The length of the period other than the On-Duration of the ShortDRX, i.e., the period in which the radio terminal does not have to receive the PDCCH in the ShortDRX differs from that of the LongDRX. That is, the interval between On-Durations in the ShortDRX is shorter than that of the LongDRX. Note that in the LTE, there is a constraint that the LongDRX must be an integral multiple of the ShortDRX. The lengths of the On-Duration and the DRX cycle are as follows. For example, the On-Duration can be set in a dozen of ways between 1 ms and 200 ms. As for the DRX cycle, each of the ShortDRX and the LongDRX can be set in a dozen of ways between 2 ms (the minimum value for the ShortDRX) and 2,560 ms (the maximum value for the LongDRX.)

Note that besides the above-described example, similarly to the On-Duration, there are conceivable cases in which a downlink data channel such as a PDSCH (Physical Downlink Shared Channel) of the LTE is received, instead of receiving the downlink control channel such as the PDCCH, in a period in which the radio terminal cyclically wakes up. For example, one of examples of the above-described case is a case in which a PDSCH of a predetermined radio resource is received without using a PDCCH, in particular, at the time of the initial transmission as in the case of continuous resource allocation (i.e., Semi-persistent scheduling) of the LTE.

Basically, DRX is controlled based on a plurality of timers as shown in FIG. 8 and each of the timers is defined as follows (Non-patent Literature 2).
drx-InactivityTimer: The number of consecutive sub-frames (PDCCH sub-frames) after a PDCCH indicating scheduling of UL (Uplink) or DL (Downlink) user data is correctly decoded.
HARQ RTT Timer: The minimum number of sub-frames until a DL HARQ is re-transmitted.
drx-RetransmissionTimer: The number of consecutive sub-frames during which the UE has to stay in ShortDRX cycle.

The length of each timer is as follows. For example, the drx-InactivityTimer can be set in about 20 ways between 1 ms and 2,560 ms. The drx-RetransmissionTimer can be set in several ways between 1 ms and 33 ms. The HARQ RTT Timer is 8 ms in an FDD (Frequency Division Duplex) system.

DRX control using these timers is explained with reference to FIG. 8.

Firstly, when the UE 10 receives new DL data during the On-Duration, it starts (restarts) the drx-InactivityTimer. Further, at the same time, the UE 10 starts the HARQ RTT Timer. When the DL data cannot be correctly decoded, the UE 10 starts the drx-RetransmissionTimer at the instant when the HARQ RTT Timer expires (Basically, the DL data is re-transmitted before the drx-RetransmissionTimer expires). The UE 10 receives the re-transmitted DL data. Then, when it is correctly decoded, the UE 10 stops the drx-RetransmissionTimer. Further, the UE 10 moves to a period in which it does not have to receive the PDCCH (i.e., an Opportunity for DRX) at the instant when the drx-InactivityTimer expires.

Note that in FIG. 8, the drx-RetransmissionTimer operates past the On-Duration period and the UE continuously receives the PDCCH past the On-Duration. This period, in which the UE continuously receives the PDCCH, is called an Active Time and the On-Duration corresponds to the minimum value for the Active Time. Further, although the UE stops the drx-Retransmission Timer when the re-transmitted DL data is correctly decoded in the above explanation, the UE may let the drx-Retransmission Timer continuously operate without stopping it. In this case, as long as either the drx-RetransmissionTimer or the drxInactivityTimer is in operation, the Active Time is extended. Then, when both of them expire, the UE moves to the period in which it does not have to receive the PDCCH. As described above, the UE determines whether or not the Active Time should be extended in each DRX cycle and thereby operates so that the UE can receive the DL data without delay.

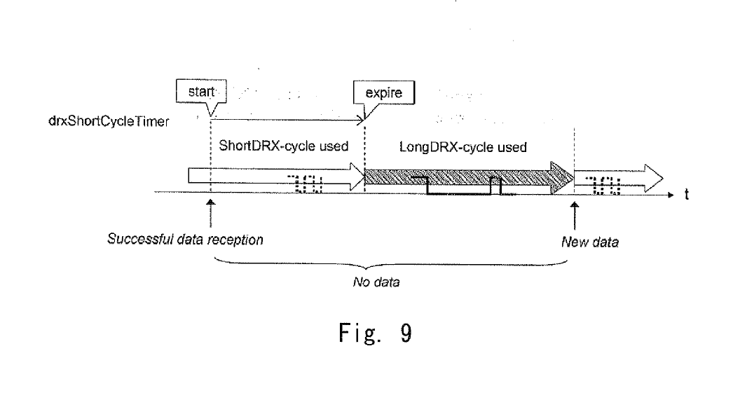

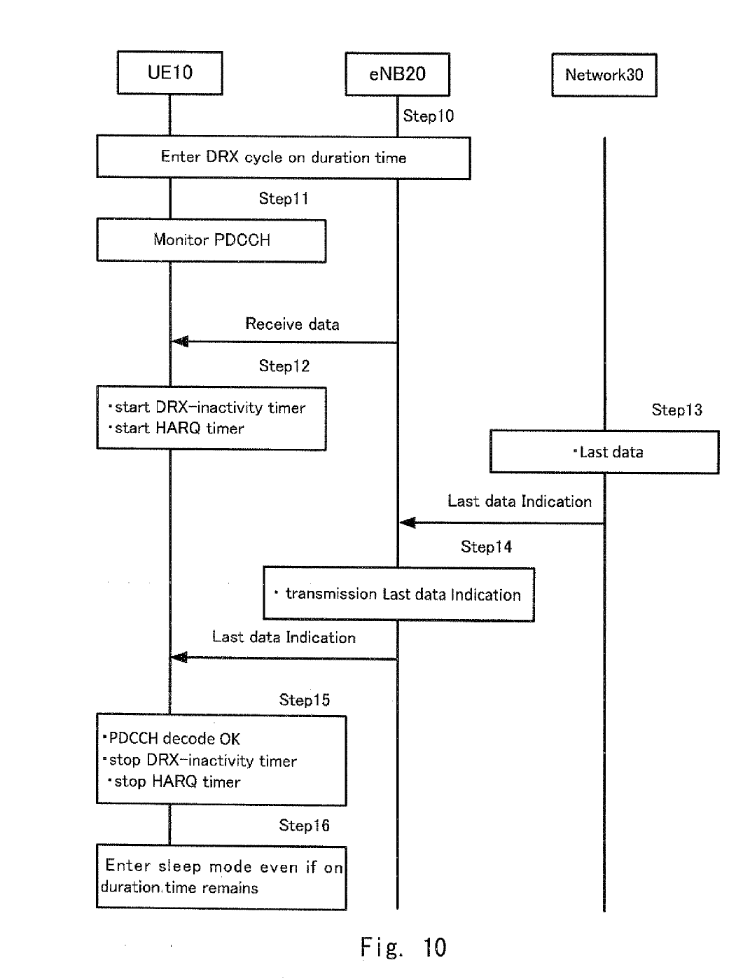

Next, DRX state (DRX level) control is explained with reference to FIG. 9.

As described previously, in DRX, there are two DRX states, i.e., a state called ShortDRX and a state called LongDRX. Basically, the UE first starts from ShortDRX and changes to LongDRX after a certain period has elapsed. The drxShortCycleTimer is used to determine this transition from the ShortDRX to the LongDRX and defined as follows (Non-patent Literature 2).
drxShortCycleTimer: The number of consecutive sub-frames during which the UE has to stay in ShortDRX cycle. FIG. 9 shows a state in which the UE has received DL data and has correctly decoded the DL data at some point during ShortDRX. The UE starts (restarts) the drxShortCyclTimer at the point when the UE has correctly decoded the DL data. When the UE receives new data while the drxShortCycleTimer is in operation, it restarts the drxShortCycleTimer again at the point when the UE has correctly decoded the DL data.

In contrast to this, when the UE does not receive new data before the drxShortCycleTimer expires as shown in FIG. 9, it changes from the ShortDRX to LongDRX. Then, when the UE receives new data after changing to the LongDRX, it changes from the LongDRX to ShortDRX again.

In the normal DRX operation, the UE operates as described above.

Next, operations that are performed when a Last data Indication (transmission end information) indicating the completion of transmission data to be transmitted to the UE 10 and performed after receiving the Last data Indication are explained.

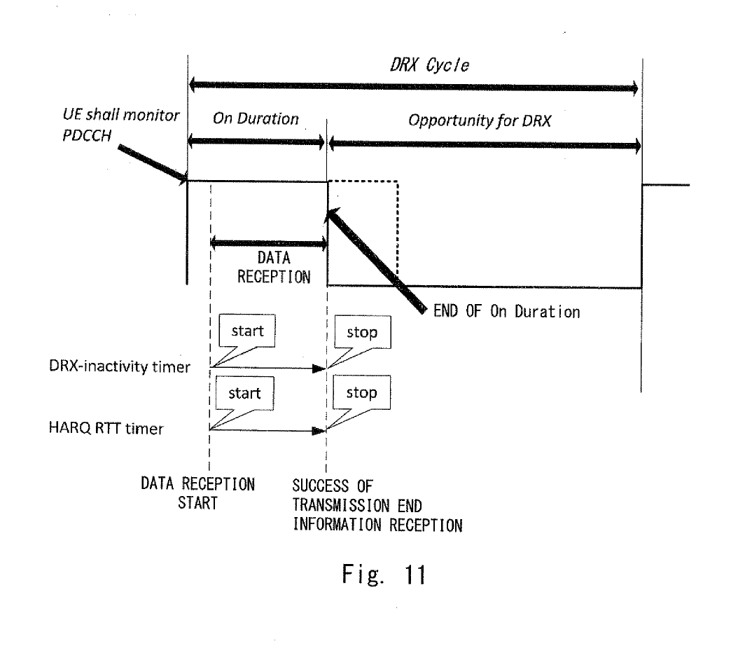

FIG. 10 is a diagram for explaining operations that are performed when the Last data Indication (the transmission end information) indicating the completion of transmission of transmission data to be transmitted to the UE 10 is transmitted and performed after receiving the Last data Indication. Further, FIG. 11 is a diagram for explaining operations that are performed when the Last data Indication (the transmission end information) indicating the completion of transmission of transmission data is received in the UE 10.

Firstly, the UE 10 and the eNB 20 enter an On-Duration of a DRX cycle (Step 10). Then, the UE 10 monitors a PDCCH transmitted from the eNB 20 (Step 11).

Next, as shown in FIGS. 10 and 11, when the UE 10 receives new DL data during the On-Duration, it starts (restarts) the drx-InactivityTimer. At the same time, it starts the HARQ RTT Timer (Step 12).

Meanwhile, when the network management apparatus 30 detects the end of transmission data to the UE 10, it transmits a Last data Indication (transmission end information) to the eNB 20 (Step 13). Upon receiving the Last data Indication (the transmission end information), the eNB 20 transfers it to the UE 10 (Step 14). Note that the Last data Indication (the transmission end information) may be transmitted as an independent message or may be incorporated into the last data. In any case, it is preferable to specify which method is used in advance.

When the UE 10 has correctly decoded the Last data Indication (the transmission end information) and hence has succeeded in the reception, it stops the drx-InactivityTimer and the HARQ RTT Timer (Step 15) and finishes the On-Duration regardless of its remaining time (Step 16) as shown in FIGS. 10 and 11. Then, the UE 10 changes to a Sleep period (an Opportunity for DRX). Note that after the transition, the UE 10 maintains the DRX cycle and resumes the operation of the On-Duration according to the DRX cycle.

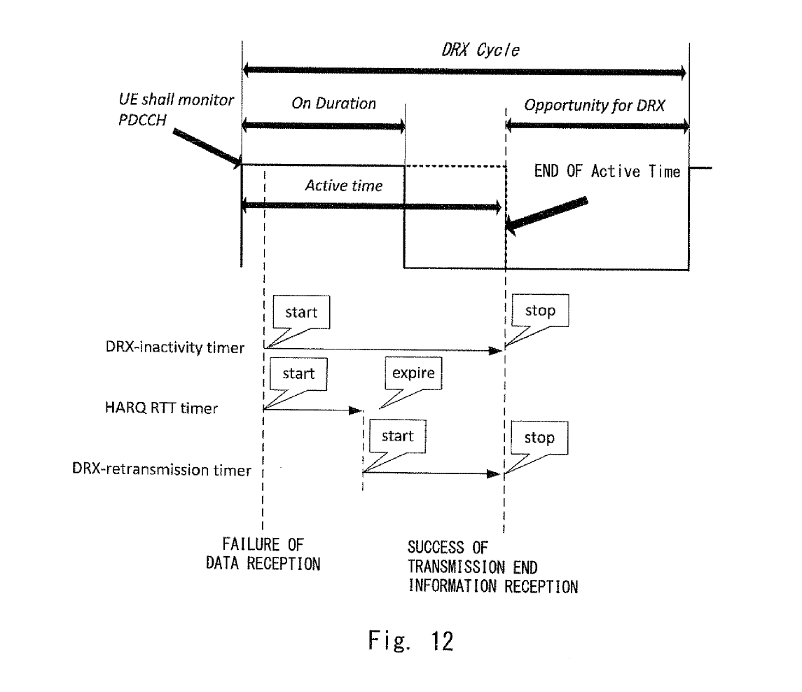

Note that FIG. 12 shows an example in which data decoding has failed.

The fundamental operation is similar to that in the above-described example. However, when the UE 10 receives new DL data during the On-Duration, it starts (restarts) the drx-InactivityTimer. Further, at the same time, the UE 10 starts the HARQ RTT Timer. When the DL data has not been correctly decoded, the UE 10 starts the drx-RetransmissionTimer at the instant when the HARQ RTT Timer expires. The UE 10 receives re-transmitted DL data. Then, when it has been correctly decoded, the UE 10 stops the drx-InactivityTimer and the drx-RetransmissionTimer and finishes the Active Time. Then, the UE 10 changes to a Sleep period (an Opportunity for DRX).

As described above, according to this embodiment, the radio terminal maintains a DRX state (a DRX level) suitable for the frequency of occurrences of data reception and can reduce the power consumption. In particular, it is effective for MTC terminals that are required to have very small power consumption.

Note that although each unit is formed by hardware in the above-described embodiments, it can be formed by a program that causes an information processing apparatus (e.g., CPU) to perform the above-described operation processes. In such cases, functions and operations similar to those in the above-described embodiments are implemented by a processor that operates by using a program stored in a program memory.

For example, as shown in FIG. 13, the radio terminal 1 can be implemented by a computer system including a memory 100 and a CPU 101. In this case, the memory 100 stores a program for performing processes corresponding to the above-described processes performed by the discontinuous reception control unit 3. Further, the functions of the discontinuous reception control unit 3 are implemented by having the CPU 101 execute the program stored in the memory 100.

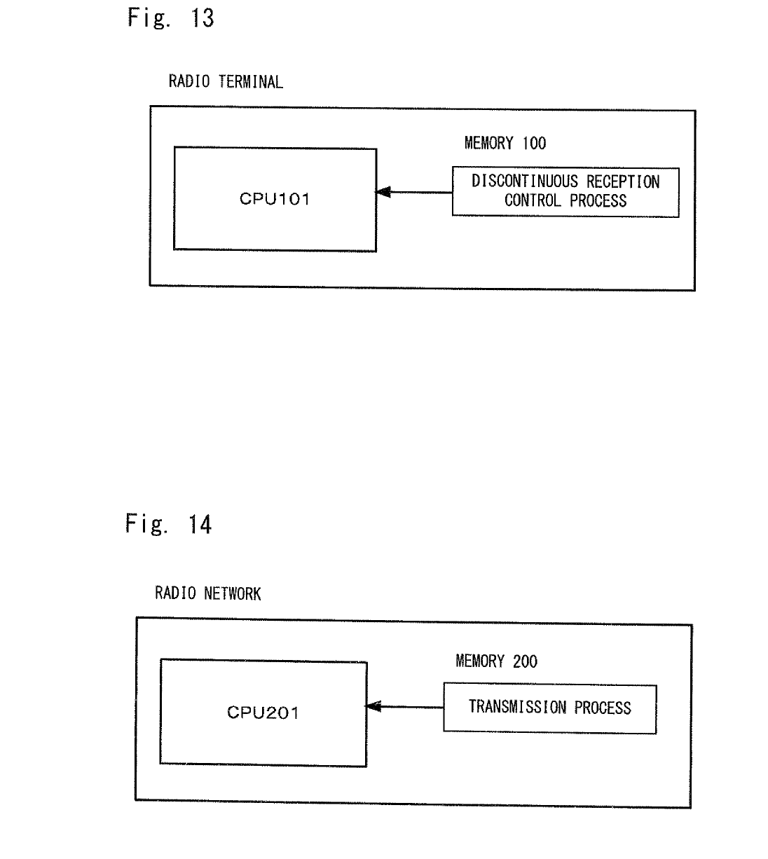

Further, as shown in FIG. 14, similarly, each of the base station including the transmission unit 2 and the radio network can also be implemented by a computer system including a memory 200 and a CPU 201. In this case, the memory 200 stores a program for performing processes corresponding to those performed by the above-described transmission unit 2. Further, the functions of the transmission unit 2 are implemented by having the CPU 201 execute the program stored in the memory 200.

Further, the whole or part of the embodiments disclosed above can be described as, but not limited to, the following supplementary notes.

### [Supplementary Note 1]

A radio communication system in which a radio terminal is able to perform discontinuous reception in a predetermined cycle, comprising:
transmission means for transmitting non-reception period transition information about a transition to a non-reception period to the radio terminal; and
discontinuous reception control means for changing to the non-reception period of the discontinuous reception based on the non-reception period transition information when the radio terminal is in a reception period of the discontinuous reception.

### [Supplementary Note 2]

The radio communication system described in Supplementary note 1, wherein the non-reception period transition information is transmission end information about an end of data to be transmitted to the radio terminal.

### [Supplementary Note 3]

The radio communication system described in Supplementary note 2, further comprising detection means for monitoring data to be transmitted to the radio terminal and detecting the end of data to be transmitted to the radio terminal.

### [Supplementary Note 4]

The radio communication system described in any one of Supplementary notes 1 to 3, wherein the reception period of the discontinuous reception is an On-Duration or an Active Time, and the non-reception period of the discontinuous reception is an Opportunity for DRX.

### [Supplementary Note 5]

The radio communication system described in any one of Supplementary notes 1 to 4, wherein the radio terminal is a machine type communication (MTC) terminal.

### [Supplementary Note 6]

A radio communication network in a communication system in which a radio terminal is able to perform discontinuous reception in a predetermined cycle, comprising transmission means for transmitting non-reception period transition information about a transition to a non-reception period to the radio terminal.

### [Supplementary Note 7]

The radio communication network described in Supplementary note 6, wherein the non-reception period transition information is transmission end information about an end of data to be transmitted to the radio terminal.

### [Supplementary Note 8]

The radio communication network described in Supplementary note 7, further comprising detection means for monitoring data to be transmitted to the radio terminal and detecting the end of data to be transmitted to the radio terminal.

### [Supplementary Note 9]

The radio communication network described in any one of Supplementary notes 6 to 8, wherein the reception period of the discontinuous reception is an On-Duration or an Active Time, and the non-reception period of the discontinuous reception is an Opportunity for DRX.

### [Supplementary Note 10]

The radio communication network described in any one of Supplementary notes 6 to 9, wherein the radio terminal is a machine type communication (MTC) terminal.

### [Supplementary Note 11]

A radio terminal configured to perform discontinuous reception of data, comprising:
reception means for receiving non-reception period transition information about a transition to a non-reception period; and
discontinuous reception control means for changing to the non-reception period of the discontinuous reception based on the non-reception period transition information during a reception period of the discontinuous reception.

### [Supplementary Note 12]

The radio terminal described in Supplementary note 11, wherein the non-reception period transition information is transmission end information about an end of data to be transmitted to the radio terminal.

### [Supplementary Note 13]

The radio terminal described in Supplementary note 11 or 12, wherein the reception period of the discontinuous reception is an On-Duration or an Active Time, and the non-reception period of the discontinuous reception is an Opportunity for DRX.

### [Supplementary Note 14]

The radio terminal described in any one of Supplementary notes 11 to 13, wherein the radio terminal is a machine type communication (MTC) terminal.

### [Supplementary Note 15]

A radio communication method in which a radio terminal is able to perform discontinuous reception in a predetermined cycle, comprising transmitting non-reception period transition information about a transition to a non-reception period from a radio network side to the radio terminal, wherein
the radio terminal changes to the non-reception period of the discontinuous reception based on the non-reception period transition information during a reception period of the discontinuous reception.

### [Supplementary Note 16]

The radio communication method described in Supplementary note 15, wherein the non-reception period transition information is transmission end information about an end of data to be transmitted to the radio terminal.

### [Supplementary Note 17]

The radio communication method described in Supplementary note 15 or 16, further comprising monitoring data to be transmitted to the radio terminal and detecting the end of data to be transmitted to the radio terminal.

### [Supplementary Note 18]

The radio communication method described in any one of Supplementary notes 15 to 17, wherein the reception period of the discontinuous reception is an On-Duration or an Active Time, and the non-reception period of the discontinuous reception is an Opportunity for DRX.

### [Supplementary Note 19]

The radio communication method described in any one of Supplementary notes 15 to 18, wherein the radio terminal is a machine type communication (MTC) terminal.

### [Supplementary Note 20]

A radio communication network in a communication system in which a radio terminal is able to perform discontinuous reception in a predetermined cycle, comprising a memory and a processor, wherein
the processor performs a transmission process for transmitting non-reception period transition information about a transition to a non-reception period to the radio terminal.

### [Supplementary Note 21]

The radio communication network described in Supplementary note 20, wherein the non-reception period transition information is transmission end information about an end of data to be transmitted to the radio terminal.

### [Supplementary Note 22]

The radio communication network described in Supplementary note 21, wherein the processor monitors data to be transmitted to the radio terminal and detects the end of data to be transmitted to the radio terminal.

### [Supplementary Note 23]

The radio communication network described in any one of Supplementary notes 20 to 22, wherein the reception period of the discontinuous reception is an On-Duration or an Active Time, and the non-reception period of the discontinuous reception is an Opportunity for DRX.

### [Supplementary Note 24]

The radio communication network described in any one of Supplementary notes 20 to 23, wherein the radio terminal is a machine type communication (MTC) terminal.

### [Supplementary Note 25]

A radio terminal configured to perform discontinuous reception of data, comprising a memory and a processor, wherein the processor performs:
a reception process of receiving non-reception period transition information about a transition to a non-reception period; and
a discontinuous reception control process of changing to the non-reception period of the discontinuous reception based on the non-reception period transition information during a reception period of the discontinuous reception.

### [Supplementary Note 26]

The radio terminal described in Supplementary note 25, wherein the non-reception period transition information is transmission end information about an end of data to be transmitted to the radio terminal.

### [Supplementary Note 27]

The radio terminal described in Supplementary note 25 or 26, wherein the reception period of the discontinuous reception is an On-Duration or an Active Time, and the non-reception period of the discontinuous reception is an Opportunity for DRX.

### [Supplementary Note 28]

The radio terminal described in any one of Supplementary notes 25 to 27, wherein the radio terminal is a machine type communication (MTC) terminal.

Although the present disclosure has been explained above by using preferred embodiments, the present disclosure is not necessarily limited to the above-described embodiments. The present disclosure can be modified and carried out in various manners without departing from the scope of its technical idea.

This application is based upon and claims the benefit of priority from Japanese patent application No. 2015-059342, filed on Mar. 23, 2015, the disclosure of which is incorporated herein in its entirety by reference.

### REFERENCE SIGNS LIST

1 RADIO TERMINAL
2 TRANSMISSION UNIT
3 DISCONTINUOUS RECEPTION CONTROL UNIT
4 RADIO COMMUNICATION NETWORK
10 UE
11 RECEIVER
12 TRANSMITTER
13 SIGNAL PROCESSING UNIT
14 COMMUNICATION CONTROL UNIT
20 eNB
21 RECEIVER
22 TRANSMITTER
23 SIGNAL PROCESSING UNIT
24 COMMUNICATION CONTROL UNIT
25 TERMINAL MANAGEMENT UNIT
30 NETWORK MANAGEMENT APPARATUS
31 RECEIVER
32 TRANSMITTER
33 TRANSMISSION DATA MANAGEMENT UNIT
100 MEMORY
101 CPU
200 MEMORY
201 CPU

1. A radio communication system in which a radio terminal is able to perform discontinuous reception in a predetermined cycle, comprising:
a transmitter configured to transmit non-reception period transition information about a transition to a non-reception period to the radio terminal; and
a discontinuous reception controller configured to change to the non-reception period of the discontinuous reception based on the non-reception period transition information when the radio terminal is in a reception period of the discontinuous reception.

2. The radio communication system according to claim 1, wherein the non-reception period transition information is transmission end information about an end of data to be transmitted to the radio terminal.

3. The radio communication system according to claim 2, further comprising a detector configured to monitor detection means for monitoring data to be transmitted to the radio terminal and detecting the end of data to be transmitted to the radio terminal.

4. The radio communication system according to claim 1, wherein the reception period of the discontinuous reception is an On-Duration or an Active Time, and the non-reception period of the discontinuous reception is an Opportunity for DRX.

5. The radio communication system according to claim 1, wherein the radio terminal is a machine type communication (MTC) terminal.

6. A radio communication network in a communication system in which a radio terminal is able to perform discontinuous reception in a predetermined cycle, comprising a transmitter configured to transmit non-reception period transition information about a transition to a non-reception period to the radio terminal.

7. The radio communication network according to claim 6, wherein the non-reception period transition information is transmission end information about an end of data to be transmitted to the radio terminal.

8. The radio communication network according to claim 7, further comprising a detector configured to monitor data to be transmitted to the radio terminal and detecting the end of data to be transmitted to the radio terminal.

9. The radio communication network according to claim 6, wherein the reception period of the discontinuous reception is an On-Duration or an Active Time, and the non-reception period of the discontinuous reception is an Opportunity for DRX.

10. The radio communication network according to claim 6, wherein the radio terminal is a machine type communication (MTC) terminal.

11. A radio terminal configured to perform discontinuous reception of data, comprising:
a receiver configured to receive non-reception period transition information about a transition to a non-reception period; and
a discontinuous reception controller configured to change to the non-reception period of the discontinuous reception based on the non-reception period transition information during a reception period of the discontinuous reception.

12. The radio terminal according to claim 11, wherein the non-reception period transition information is transmission end information about an end of data to be transmitted to the radio terminal.

13. The radio terminal according to claim 11, wherein the reception period of the discontinuous reception is an On-Duration or an Active Time, and the non-reception period of the discontinuous reception is an Opportunity for DRX.

14. The radio terminal according to claim 11, wherein the radio terminal is a machine type communication (MTC) terminal.

15. A radio communication method in which a radio terminal is able to perform discontinuous reception in a predetermined cycle, comprising transmitting non-reception period transition information about a transition to a non-reception period from a radio network side to the radio terminal, wherein
the radio terminal changes to the non-reception period of the discontinuous reception based on the non-reception period transition information during a reception period of the discontinuous reception.

16. The radio communication method according to claim 15, wherein the non-reception period transition information is transmission end information about an end of data to be transmitted to the radio terminal.

17. The radio communication method according to claim 15, further comprising monitoring data to be transmitted to the radio terminal and detecting the end of data to be transmitted to the radio terminal.

18. The radio communication method according to claim 15, wherein the reception period of the discontinuous reception is an On-Duration or an Active Time, and the non-reception period of the discontinuous reception is an Opportunity for DRX.

19. The radio communication method according to claim 15, wherein the radio terminal is a machine type communication (MTC) terminal.
